(19) United States
(12) Patent Application Publication
(10) Pub. No.: US 2018/0156838 A1
(43) Pub. Date: Jun. 7, 2018

(54) WALKING DETERMINATION METHOD AND RECORDING MEDIUM HAVING RECORDED THEREIN WALKING DETERMINATION PROGRAM

(71) Applicant: SCREEN Holdings Co., Ltd., Kyoto-shi (JP)

(72) Inventor: Kazuki NISHIDA, Kyoto (JP)

(21) Appl. No.: 15/829,024

(22) Filed: Dec. 1, 2017

(30) Foreign Application Priority Data
Dec. 5, 2016 (JP) 2016-235587

(51) Int. Cl. G01P 15/08; G01C 22/00

(52) U.S. Cl. CPC G01P 15/0802; G01C 21/16; G01C 22/006

(57) ABSTRACT

There are provided an acceleration data obtaining step of obtaining acceleration data for a predetermined period of time; an analyzing step of obtaining, as an analysis result, output intensity corresponding to each combination of time and frequency by performing frequency analysis on the acceleration data; and a determining step of determining whether a user is walking, taking into account the analysis result obtained in the analyzing step. In the determining step, a period during which output intensity is greater than or equal to a predetermined intensity threshold value in a predetermined frequency band range is set as a presumed walking period, and the determination as to whether the user is walking is made taking into account a ratio of the presumed walking period to the predetermined period of time.

### BACKGROUND OF THE INVENTION

### Field of the Invention

The present invention relates to a method for determining whether a user of a portable terminal device is walking (walking determination method).

### Description of Related Art

Due to the increased functionality and increased resolution of portable terminal devices such as mobile phones, many application software that uses a map has been developed in recent years. As one of such application software, there is known application software called a “route guidance app”, etc., for guiding a user of a portable terminal device (hereinafter, referred to as “user”) to a destination. The route guidance app searches for a route from a user's current location to a destination and displays a result of the search, together with a map, on a screen of the portable terminal device. By using such a route guidance app, the user can easily get to the destination even if there is no map at hand.

In general, the route guidance app not only searches for a shortest-distance route, but also searches for a shortest-time route. In addition, the route guidance app not only displays the route on the screen, but also displays the predicted time required to get to the destination from the current location. As described above, the route guidance app needs to predict the time required for travel. Regarding this, in order to increase the accuracy of the prediction, there is a need to consider the congestion conditions on the route. Hence, there is also developed a route guidance app that estimates the congestion degree and makes a prediction (a prediction of the time required for travel) taking into account the congestion conditions on a route.

Note that in relation to this invention, Japanese Laid-Open Patent Publication No. 2005-287708 discloses an invention of a movement evaluation device that determines whether a person is walking, based on acceleration data. In addition, there is also a research that attempts to classify walking states into three modes (walking on flat ground, walking upstairs, and walking down stairs) based on acceleration data.

Meanwhile, regarding a route guidance app for pedestrians, it is conceivable to obtain information about walking of each user based on data that is obtained from various types of sensors mounted on each portable terminal device (hereinafter, referred to as “sensor data”) and put together the information on the server side to estimate the congestion degree for each area, each road, etc. However, some users may not be performing normal walking due to a tourist activity, shopping, waiting at a traffic signal, etc. (which are hereinafter collectively referred to as “tourist activity, etc.”). In such a case, sensor data that is obtained from portable terminal devices carried by the users (hereinafter, simply referred to as “sensor data of the users”) does not serve as data useful for estimating the congestion degree, but rather serves as noise data that inhibits the accurate estimation of the congestion degree. Therefore, in order to accurately estimate the congestion degree, there is a need to exclude the sensor data of the users that are doing a tourist activity, etc., from data that is the source of estimation of the congestion degree. In other words, in order to increase the accuracy of estimation of the congestion degree, it is necessary to use only sensor data of users who are walking upon estimation of the congestion degree. Note that in the invention disclosed in Japanese Laid-Open Patent Publication No. 2005-287708, a determination as to whether a person is walking is made based on acceleration data; however, since a specific determination is made based on whether there is a periodic waveform change, an accurate determination cannot be made when there is a change in walking speed.

### SUMMARY OF THE INVENTION

An object of the present invention is therefore to provide a method for accurately determining whether a user of a portable terminal device is walking.

To attain the above-described object, the present invention has features shown below.

One aspect of the present invention is directed to a walking determination method for determining whether a user of a portable terminal device is walking, the walking determination method including:

an acceleration data obtaining step of obtaining acceleration data representing acceleration of the portable terminal device for a predetermined period of time;

an analyzing step of obtaining, as an analysis result, output intensity corresponding to each combination of time and frequency by performing frequency analysis on the acceleration data; and

a determining step of determining whether the user is walking, taking into account the analysis result obtained in the analyzing step.

According to such a configuration, the portable terminal device performs frequency analysis on acceleration data, and obtains output intensity corresponding to each combination of time and frequency, as the results of the analysis. That is, regarding acceleration data, a temporal change in each frequency component can be grasped. Since a change in human movement is reflected in acceleration data, it becomes possible to determine whether a user of the portable terminal device is walking by grasping a temporal change in each frequency component regarding the acceleration data.

Another aspect of the present invention is directed to a computer-readable recording medium having recorded therein a walking determination program for determining whether a user of a portable terminal device is walking, the walking determination program causing a computer to perform:

an acceleration data obtaining step of obtaining acceleration data representing acceleration of the portable terminal device for a predetermined period of time;

an analyzing step of obtaining, as an analysis result, output intensity corresponding to each combination of time and frequency by performing frequency analysis on the acceleration data; and

a determining step of determining whether the user is walking, taking into account the analysis result obtained in the analyzing step.

These and other objects, features, modes, and effects of the present invention will be made clear from the following detailed description of the present invention with reference to the accompanying drawings.

### BRIEF DESCRIPTION OF THE DRAWINGS

FIG. 1 is a block diagram showing a device configuration that implements a route guidance system according to an embodiment of the present invention.

FIG. 2 is a block diagram showing a hardware configuration of a portable terminal device in the embodiment.

FIG. 3 is a block diagram showing a hardware configuration of a server in the embodiment.

FIG. 4 is a block diagram showing a detailed functional configuration of the route guidance system in the embodiment.

FIG. 5 is a diagram showing a record format of acceleration data in the embodiment.

FIG. 6 is a diagram showing a record format of congestion degree data in the embodiment.

FIG. 7 is a diagram showing an example of a screen displayed on a display unit in the embodiment.

FIG. 8 is a diagram showing a record format of average congestion degree data in the embodiment.

FIG. 9 is a flowchart showing a procedure of a process (congestion degree estimation process) performed by the portable terminal device in the embodiment.

FIG. 10 is a diagram for describing standard deviation normalization in the embodiment.

FIG. 11 is a diagram for describing conversion from standard deviation to the congestion degree in the embodiment.

FIG. 12 is a flowchart showing a procedure of a process (average congestion degree estimation process) performed by the server in the embodiment.

FIG. 13 is a diagram showing a record format of mesh definition data in the embodiment.

FIG. 14 is a diagram schematically showing allocation of congestion degree data to meshes in the embodiment.

FIG. 15 is a diagram representing Gabor functions regarding the embodiment.

FIG. 16 is a diagram for describing display of a component distribution based on the results of a wavelet transform regarding the embodiment.

FIG. 17 is a diagram showing a first example of a component distribution in the embodiment.

FIG. 18 is a diagram schematically showing, by a thick line, a portion in which output intensity greater than or equal to an intensity threshold value appears in the first example of a component distribution in the embodiment.

FIG. 19 is a diagram showing a second example of a component distribution in the embodiment.

FIG. 20 is a diagram showing a third example of a component distribution in the embodiment.

FIG. 21 is a diagram schematically showing, by a thick line, a portion in which output intensity greater than or equal to the intensity threshold value appears in the third example of a component distribution in the embodiment.

FIG. 22 is a diagram showing a fourth example of a component distribution in the embodiment.

FIG. 23 is a diagram schematically showing, by a thick line, a portion in which output intensity greater than or equal to the intensity threshold value appears in the fourth example of a component distribution in the embodiment.

FIG. 24 is a diagram for describing a walking ratio in the embodiment.

FIG. 25 is a flowchart showing a procedure of a walking determination process in the embodiment.

FIG. 26 is a flowchart showing a procedure of a walking determination process for the case of making only a determination based on acceleration data in a variant of the embodiment.

### DETAILED DESCRIPTION OF PREFERRED EMBODIMENTS

An embodiment of the present invention will be described below with reference to the accompanying drawings. Note that in the following “application software” is abbreviated as “app”.

### <1. Overall Configuration>

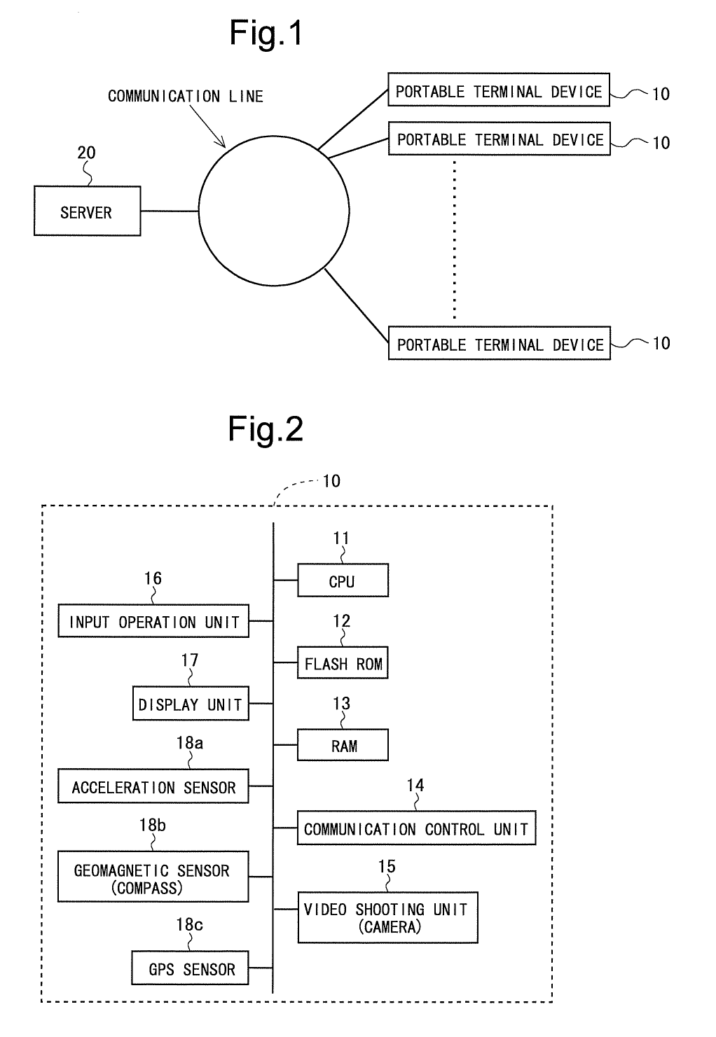

FIG. 1 is a block diagram showing a device configuration that implements a route guidance system according to an embodiment of the present invention. The route guidance system is implemented by a server 20 and a plurality of portable terminal devices 10. The server 20 and the portable terminal devices 10 are connected to each other through a communication line such as the Internet. In the present embodiment, in order to implement the route guidance system, a route guidance app is installed on the portable terminal devices 10. The route guidance app is a software for presenting, when a user travels to a given destination for sightseeing, shopping, etc., a route from a current location to the destination to the user. The user can activate the route guidance app by performing a predetermined operation. By installing such a route guidance app on the portable terminal device 10, even when, for example, the user visits an unfamiliar tourist spot, the user can easily get to a destination by using the route guidance app.

Note that the portable terminal device 10 as used herein is a concept including not only a general mobile phone but also a so-called wearable terminal such as a head-mounted display.

### <2. Hardware Configuration>

FIG. 2 is a block diagram showing a hardware configuration of the portable terminal device 10. The portable terminal device 10 includes a CPU 11, a flash ROM 12, a RAM 13, a communication control unit 14, a video shooting unit (camera) 15, an input operation unit 16, a display unit 17, an acceleration sensor 18a, a geomagnetic sensor (compass) 18b, and a GPS sensor 18c. The CPU 11 performs various types of arithmetic processing, etc., to control the entire portable terminal device 10. The flash ROM 12 is a nonvolatile writable memory and stores various types of programs and various types of data that need to be held even if the power of the portable terminal device 10 is turned off. The RAM 13 is a volatile writable memory and temporarily stores a program being executed, data, etc. The communication control unit 14 performs control of data transmission to an external source and control of data reception from an external source. The video shooting unit (camera) 15 shoots a view that can be seen from a current location, based on a user's operation. The input operation unit 16 is, for example, a touch panel and accepts user's input operations. The display unit 17 displays images based on an instruction from the CPU 11. The acceleration sensor 18a measures acceleration based on the movement of the portable terminal device 10. The geomagnetic sensor (compass) 18b detects an azimuth in which the portable terminal device 10 is oriented (e.g., an azimuth in which the display unit 17 is oriented). The GPS sensor 18c obtains information on latitude and longitude for identifying a user's current location, based on radio waves received from a GPS satellite.

In the portable terminal device 10, a route guidance program that implements the route guidance app is stored in the flash ROM 12. When the user gives an instruction for activating the route guidance app, the route guidance program stored in the flash ROM 12 is read into the RAM 13, and the CPU 11 executes the route guidance program read into the RAM 13, by which a function of the route guidance app is provided to the user. Note that the route guidance program is typically downloaded from a predetermined server (not shown) to the portable terminal device 10 through the communication line such as the Internet, and is installed in the flash ROM 12 in the portable terminal device 10. Alternatively, the route guidance program may be provided stored in a computer-readable recording medium (non-transient recording medium) such as a CD-ROM or a DVD-ROM.

In the present embodiment, a walking determination program for determining whether a user is walking is embedded in the route guidance program. The walking determination program is executed by the CPU 11 upon performing a walking determination process which will be described later.

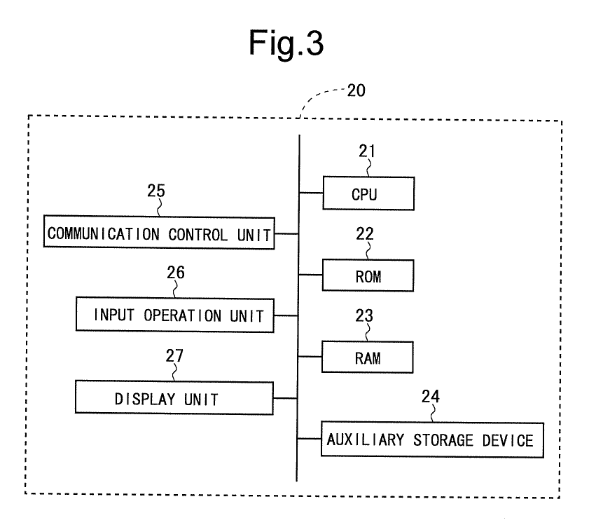

FIG. 3 is a block diagram showing a hardware configuration of the server 20. The server 20 includes a CPU 21, a ROM 22, a RAM 23, an auxiliary storage device 24, a communication control unit 25, an input operation unit 26, and a display unit 27. The CPU 21 performs various types of arithmetic processing, etc., to control the entire server 20. The ROM 22 is a read-only memory and stores, for example, an initial program to be executed by the CPU 21 at startup of the server 20. The RAM 23 is a volatile writable memory and temporarily stores a program being executed, data, etc. The auxiliary storage device 24 is a magnetic disk device, etc., and stores various types of programs and various types of data that need to be held even if the power of the server 20 is turned off. The communication control unit 25 performs control of data transmission to an external source and control of data reception from an external source. The input operation unit 26 is, for example, a keyboard and a mouse and accepts operator's input operations. The display unit 27 displays images based on an instruction from the CPU 21. Note that the ROM 22 or the auxiliary storage device 24 in the server 20 stores a program for calculating an average congestion degree using data which is transmitted from each portable terminal device 10.

### <3. Functional Configuration>

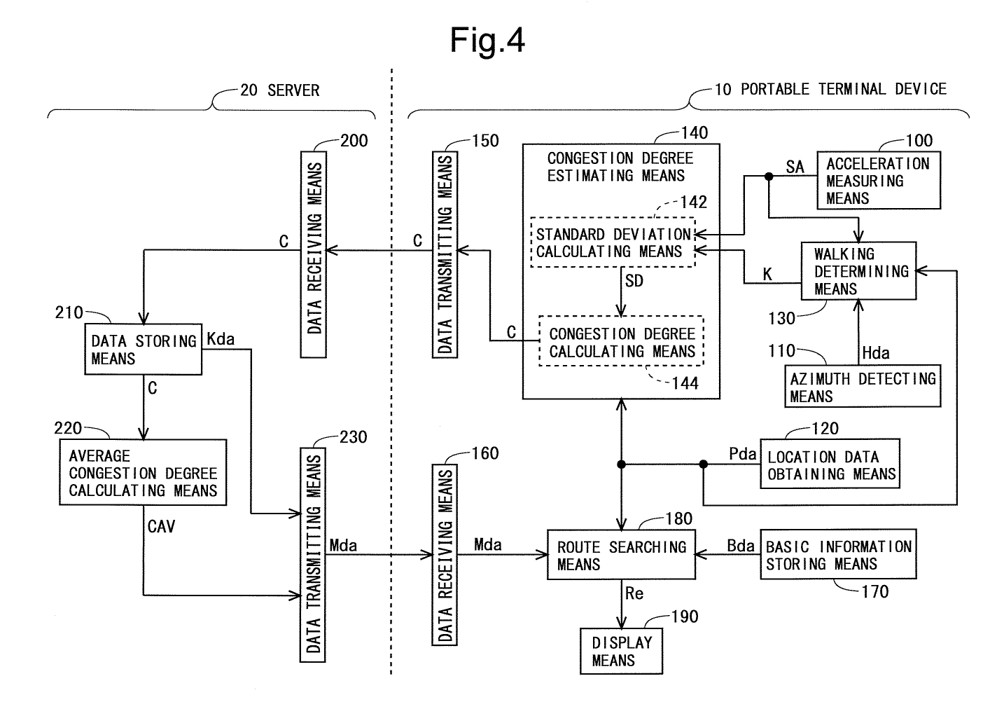

FIG. 4 is a block diagram showing a detailed functional configuration of the route guidance system. As described above, the route guidance system is implemented by the portable terminal devices 10 and the server 20. Each portable terminal device 10 includes an acceleration measuring means 100, an azimuth detecting means 110, a location data obtaining means 120, a walking determining means 130, a congestion degree estimating means 140, a data transmitting means 150, a data receiving means 160, a basic information storing means 170, a route searching means 180, and display means 190. The congestion degree estimating means 140 includes a standard deviation calculating means 142 and a congestion degree calculating means 144. The server 20 includes a data receiving means 200, a data storing means 210, an average congestion degree calculating means 220, and a data transmitting means 230.

### <3.1 Operation of the Components of the Portable Terminal Device>

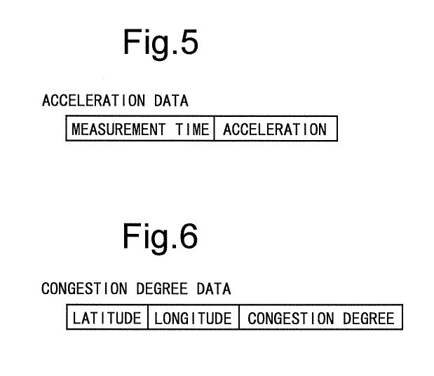

The operation of each component of the portable terminal device 10 will be described. The acceleration measuring means 100 measures acceleration based on the movement of the portable terminal device 10 which results from user's movement, and outputs acceleration data including, for example, as shown in FIG. 5, information on a measurement time and information on the acceleration which is a measured value. Note that, for convenience sake, in the present specification, the acceleration itself which serves as a measured value and the above-described acceleration data are denoted by the same reference character SA. The same also applies to the congestion degree and congestion degree data, and an average congestion degree and average congestion degree data. Measurement of acceleration SA by the acceleration measuring means 100 is performed, for example, every 70 milliseconds. The azimuth detecting means 110 detects an azimuth in which the portable terminal device 10 is oriented, and outputs a result of the detection as azimuth data Hda. The location data obtaining means 120 obtains information on latitude and longitude for identifying a user's current location based on radio waves received from a GPS satellite, and outputs the information on latitude and longitude as location data Pda.

Note that the acceleration measuring means 100 is implemented by the acceleration sensor 18a which is hardware, the azimuth detecting means 110 is implemented by the geomagnetic sensor 18b which is hardware, and the location data obtaining means 120 is implemented by the GPS sensor 18c which is hardware (see FIG. 2).

The walking determining means 130 determines whether the user is walking, based on the acceleration data SA, the azimuth data Hda, and the location data Pda, and outputs a determination result K. Note that a detailed description of a process that makes this determination (walking determination process) will be made later.

The congestion degree estimating means 140 estimates a congestion degree C. at a location where the user is walking, based on the location data Pda, the acceleration data SA, and the determination result K obtained by the walking determining means 130, and outputs congestion degree data C including the information on latitude and longitude and information on the congestion degree. More specifically, when the determination result K indicates that the user is walking, the standard deviation calculating means 142 included in the congestion degree estimating means 140 obtains standard deviation SD of acceleration SA, for example, for the last 10 seconds, based on the acceleration data SA. In addition, the congestion degree calculating means 144 included in the congestion degree estimating means 140 calculates a congestion degree C. based on the standard deviation SD (converts the standard deviation SD to the congestion degree C.), and outputs congestion degree data C having a record format such as that shown in FIG. 6, for example. A detailed description of how to obtain the standard deviation SD and how to obtain the congestion degree C. will be made later. Note that a method for estimating the congestion degree C. which is described in the present specification is an example and the method is not limited thereto.

The data transmitting means 150 transmits the congestion degree data C to the server 20. Transmission of the congestion degree data C by the data transmitting means 150 is performed, for example, every minute. The data receiving means 160 receives from the server 20 significant information Mda which is data useful for a route search (a search for a route from a user's current location to a destination by the route searching means 180). In the basic information storing means 170 is stored basic information Bda which is required upon a route search. The basic information storing means 170 is implemented by the flash ROM 12 or the RAM 13 (see FIG. 2) which is hardware. The basic information Bda includes a map, road information, etc. The road information includes, for example, information on the location of each road (information on a start point and an end point), information on a distance from the start point to the end point, and information on a road width. Note that the configuration may be such that the data transmitting means 150 transmits location data Pda to the server 20 at appropriate timing, and basic information Bda to be stored in the basic information storing means 170 is downloaded from the server 20 to the portable terminal device 10.

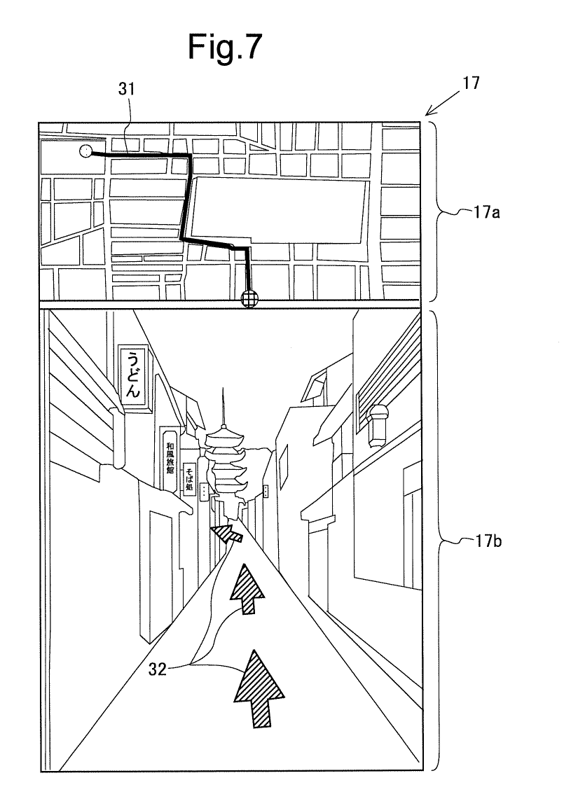

The route searching means 180 accepts a user's input of a destination and searches for a route to the destination based on the location data Pda, the significant information Mda, and the basic information Bda. A route search result Re obtained by the route searching means 180 is displayed on the display means 190 (the display unit 17 in FIG. 2). When a route search is performed, for example, a screen such as that shown in FIG. 7 is displayed on the display unit 17. In the example shown in FIG. 7, a region of the display unit 17 is divided into a region (map display region) 17a for displaying a map and a region (video display region) 17b for displaying video (video of a view) which is obtained by shooting by the video shooting unit 15 (see FIG. 2). In the map display region 17a, a route to a destination is indicated by a thick line denoted by reference character 31. In the video display region 17b, the route to the destination is represented by arrow-shaped AirTags (augmented-reality images) which are denoted by reference character 32.

### <3.2 Operation of the Components of the Server>

Next, the operation of each component of the server 20 will be described. The data receiving means 200 receives the congestion degree data C transmitted from the portable terminal device 10. The congestion degree data C is stored in the data storing means 210. Note that the congestion degree data C received by the data receiving means 200 includes pieces of data on various locations (latitude and longitude), and those pieces of data are classified into data for each mesh and stored in the data storing means 210. Moreover, the data storing means 210 stores route search data Kda to be transmitted to the portable terminal device 10, in addition to the congestion degree data C.

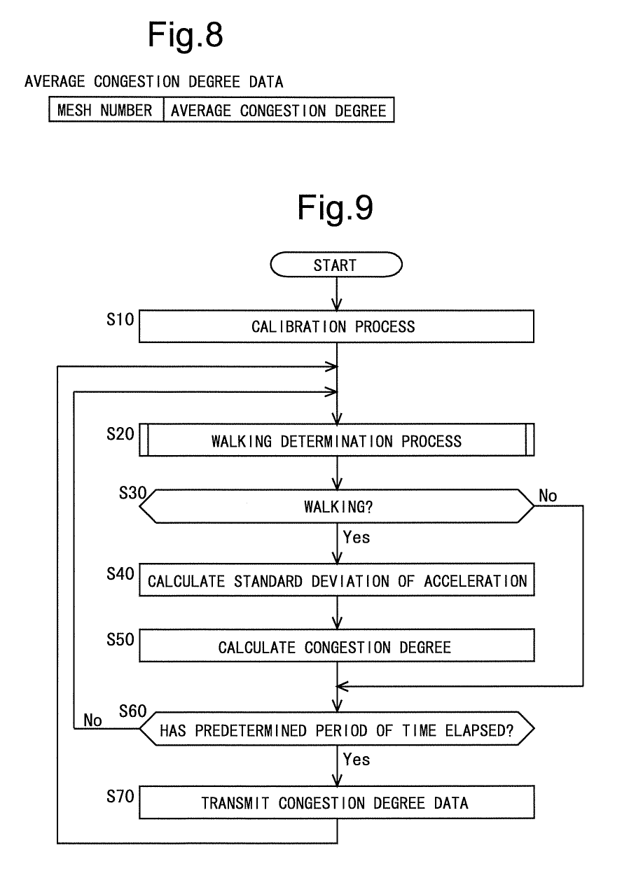

The average congestion degree calculating means 220 calculates an average congestion degree CAV for each mesh, based on the congestion degree data C stored in the data storing means 210. By this, average congestion degree data CAV having a record format such as that shown in FIG. 8, for example, is outputted. The data transmitting means 230 transmits the average congestion degree data CAV outputted from the average congestion degree calculating means 220 and the route search data Kda stored in the data storing means 210, as the significant information Mda, to the portable terminal device 10. In this manner, information on the average congestion degree CAV for each mesh is provided to the portable terminal device 10. Thus, in the portable terminal device 10, the route searching means 180 performs a route search taking into account the congestion conditions on a route.

### <4. Congestion Analysis Process>

The route guidance system according to the present embodiment performs a process of analyzing road congestion conditions (congestion analysis process). Regarding this, first, each portable terminal device 10 estimates the congestion degree at a location at which a user is currently present, using only data that is obtained by the relevant portable terminal device 10. Congestion degree data C which is obtained as a result of the estimation of the congestion degree performed by each portable terminal device 10 is transmitted to the server 20. Then, the server 20 puts together the pieces of congestion degree data C transmitted from the multiple portable terminal devices 10, and estimates an average congestion degree CAV for each mesh. As such, by the congestion analysis process, finally, data on the average congestion degree CAV for each mesh is obtained. Each of a process (congestion degree estimation process) performed by the portable terminal devices 10 and a process (average congestion degree estimation process) performed by the server 20 will be described in detail below.

<4.1 Process Performed by the Portable Terminal Devices>

FIG. 9 is a flowchart showing a procedure of a process (congestion degree estimation process) performed by each portable terminal device 10. When the route guidance app is activated on the portable terminal device 10, the portable terminal device 10 first performs a calibration process for obtaining data that is required when normalization is performed in a process at step S40 which will be described later (step S10). A detailed description of the calibration process will be made later.

After the completion of the calibration process, the walking determining means 130 performs a walking determination process for determining whether a user of the portable terminal device 10 is walking (step S20). As a result of the walking determination process, if it is determined that the “user is walking”, processing proceeds to step S40, and if it is determined that the “user is not walking”, processing proceeds to step S60 (step S30). Note that a detailed description of the walking determination process will be made later.

At step S40, the standard deviation calculating means 142 calculates standard deviation SD of acceleration SA, for example, for the last 10 seconds. In general, when a person is walking in a crowded place, he/she walks with short steps and his/her overall movement is small, resulting in small variations in acceleration. On the other hand, when a person is walking in an uncrowded place, he/she walks with long steps and his/her overall movement is large, resulting in large variations in acceleration. As such, variations in acceleration change depending on the level of congestion. Hence, the congestion degree is estimated using standard deviation (of acceleration) serving as an index for variations in acceleration.

Meanwhile, since each person has individuality, the way of walking varies from person to person. Hence, even if the standard deviation of acceleration is the same for pieces of data on given two users, it does not necessarily mean that their levels of congestion are the same. In particular, it is considered that the characteristics of human walking emerge when walking in an uncrowded place. Therefore, it is considered that the maximum value of the standard deviation of acceleration varies from person to person. Note that it is considered that when the place is so crowded that people cannot move, the standard deviation of acceleration is substantially 0 for most people. In view of this, in the present embodiment, in order to absorb differences in the way of walking between people, normalization is performed for each portable terminal device 10 such that the maximum value of the standard deviation of acceleration is 1.0. For this normalization, the calibration process (step S10) is performed.

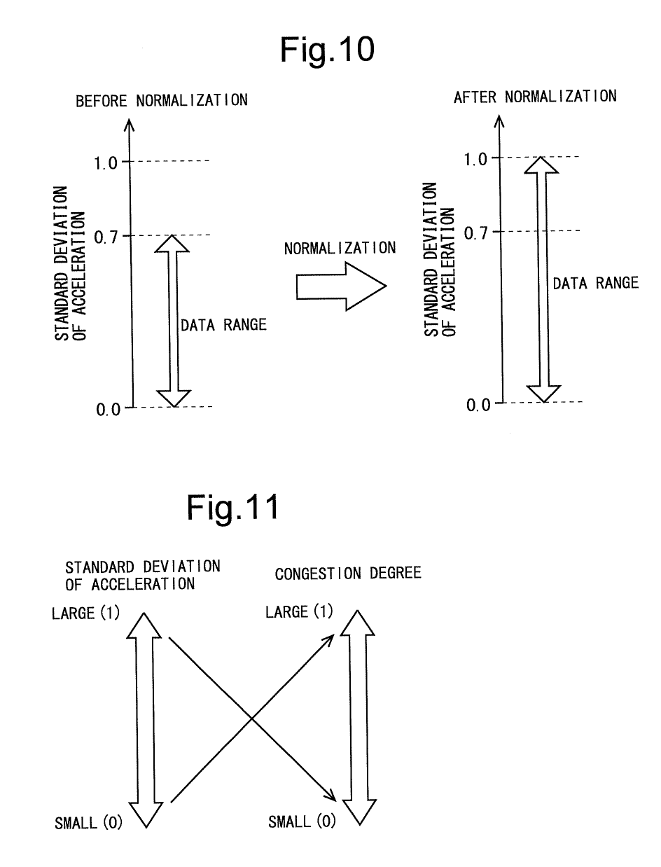

In the calibration process, standard deviation of acceleration is obtained, for example, every 10 seconds for a predetermined period (e.g., 10 minutes) after the activation of the route guidance app. Then, the maximum value of the standard deviation obtained during the predetermined period is set as a normalized value corresponding to 1.0. For example, it is assumed that the maximum value of standard deviation of acceleration is 0.7 as a result of a calibration process. In this case, at step S40, as shown in FIG. 10, normalization is performed such that values in a range from 0.0 to 0.7 become values in a range from 0.0 to 1.0.

After calculating the standard deviation SD of acceleration SA in the above-described manner, the congestion degree calculating means 144 calculates a congestion degree C. based on the standard deviation SD (step S50). In the present embodiment, the congestion degree C. is represented by a value from 0 to 1. The closer the value of the congestion degree C. to 1, the greater the level of congestion. Meanwhile, as described above, the standard deviation SD of acceleration SA is small when a person is walking in a crowded place, and is large when a person is walking in an uncrowded place. Thus, at step S50, as shown in FIG. 11, the congestion degree C. is calculated such that the closer the standard deviation SD of acceleration SA is to 1, the closer the congestion degree C. is to 0, and the closer the standard deviation SD of acceleration SA is to 0, the closer the congestion degree C. is to 1. The congestion degree C. is obtained, for example, by subtracting the value of the standard deviation SD from 1.

After calculating the congestion degree C., it is determined whether a predetermined period of time (e.g., one minute) has elapsed (step S60). As a result, if the predetermined period of time has elapsed, processing proceeds to step S70, and if the predetermined period of time has not elapsed, processing returns to step S20.

At step S70, congestion degree data C which is accumulated during the predetermined period of time is transmitted from the portable terminal device 10 to the server 20. Note, however, that if congestion degree data C is not accumulated at all, transmission of congestion degree data C to the server 20 is not performed. After transmitting the congestion degree data C to the server 20, processing returns to step S20. Thereafter, the processes at step S20 to S70 are repeated until the route guidance app is terminated.

### <4.2 Process Performed by the Server>

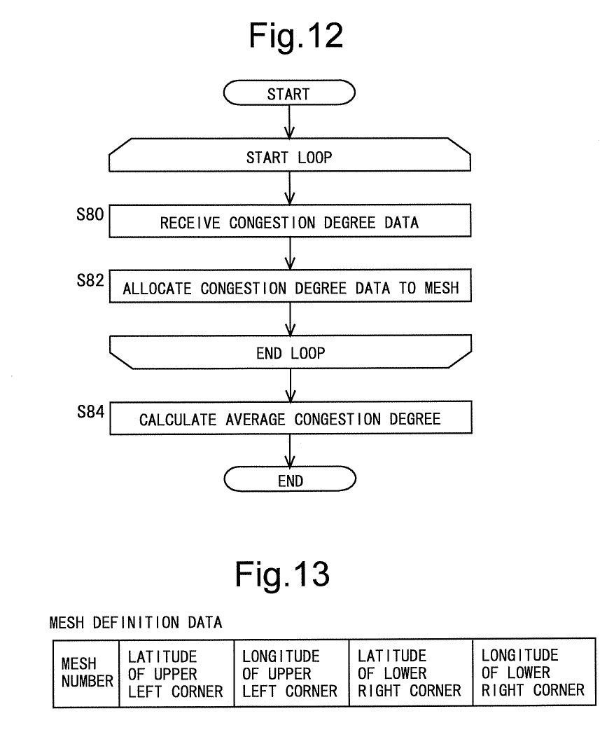

FIG. 12 is a flowchart showing a procedure of a process (average congestion degree estimation process) performed by the server 20. The server 20 first performs a process of accumulating congestion degree data C which is transmitted from each portable terminal device 10 (step S80 and S82). More specifically, the server 20 receives congestion degree data C which is transmitted from each portable terminal device 10 (step S80) and allocates the received congestion degree data C to a corresponding mesh (step S82). The processes at step S80 and S82 are performed every time congestion degree data C is transmitted from a portable terminal device 10 and until a predetermined period (e.g., 15 minutes) has elapsed from the last execution of the average congestion degree estimation process.

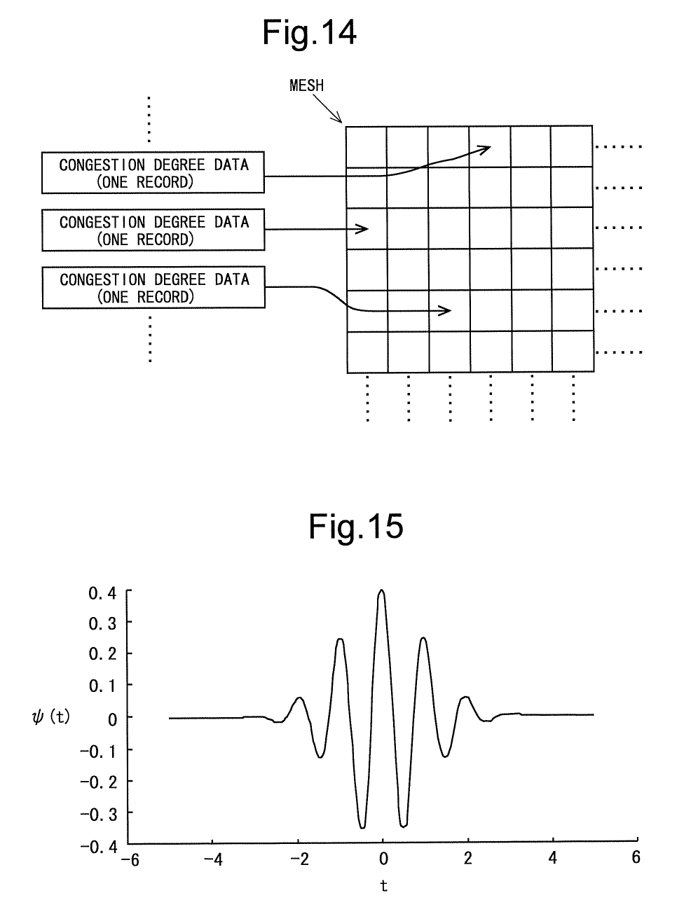

Now, allocation (classification) of congestion degree data C to a mesh will be described. One record of congestion degree data C which is transmitted from a portable terminal device 10 includes information on latitude and longitude and information on the congestion degree (see FIG. 6). In addition, the server 20 pre-holds, as data that defines each mesh, mesh definition data having a record format such as that shown in FIG. 13, for example. As shown in FIG. 13, the mesh definition data includes information on the latitude and longitude of the upper left corner of each mesh and information on the latitude and longitude of the lower right corner of the mesh. From the above, by referring to the mesh definition data, each record of congestion degree data C can be allocated to a corresponding mesh as schematically shown in FIG. 14. Note that it is also possible to prepare a conversion equation for obtaining a mesh number from information on latitude and longitude, and allocate each record of congestion degree data C to a corresponding mesh based on the conversion equation.

After the predetermined period (e.g., 15 minutes) has elapsed from the last execution of the average congestion degree estimation process, the average congestion degree calculating means 220 calculates an average congestion degree CAV for each mesh based on the accumulated congestion degree data C (step S84). For example, if three pieces of congestion degree data C, “the congestion degree=0.1”, “the congestion degree=0.15”, and “the congestion degree=0.35”, are accumulated for a given mesh, the average congestion degree CAV for the mesh is 0.2. In this manner, data on the average congestion degree CAV for each mesh is obtained.

In the above-described manner, a single average congestion degree estimation process (processes from step S80 to S84) ends. Note that after calculating the average congestion degree CAV, for example, estimation of the number of people for each mesh can also be performed using data on the average congestion degree CAV.

### <5. Walking Determination Process>

### <5.1 Summary>

Now, the walking determination process (the process at step S20 in FIG. 9) in the present embodiment will be described. As described above, in order to accurately estimate the congestion degree, there is a need to exclude data on users that are doing a tourist activity, etc., from data that is the source of estimation of the congestion degree (in the present embodiment, the average congestion degree CAV for each mesh). Hence, upon a congestion degree estimation process, each portable terminal device 10 performs a walking determination process for determining whether a user is walking. In the present embodiment, specifically, the following three types of determination processes are prepared. A first determination process is a process of making a determination based on acceleration data SA (more specifically, a process of performing frequency analysis on acceleration data SA and making a determination based on the results of the frequency analysis). A second determination process is a process of making a determination based on azimuth data Hda. A third determination process is a process of making a determination based on location data Pda. Only when it is determined (tentatively determined) in all of those three types of determination processes that the “user is walking”, a final determination result indicating that the “user is walking” is obtained. In other words, if it is determined in any one of the three types of determination processes that the “user is not walking”, a final determination result indicating that the “user is not walking” is obtained. The three types of determination processes will be described in detail below.

### <5.2 First Determination Process (Determination Based on Acceleration Data)>

As described above, the first determination process is a process of making a determination based on acceleration data SA (a process of performing frequency analysis on acceleration data SA and making a determination based on the results of the frequency analysis). In the present embodiment, as specific means for performing frequency analysis, wavelet analysis is adopted. Wavelet analysis is frequency analysis means for performing a process (wavelet transform) of computing the inner product of a function (wavelet function), which is obtained by stretching or shrinking and shifting a function called a mother wavelet in a time-axis direction, and a signal to be analyzed, and thereby obtaining a component distribution for combinations of time and frequency for the signal to be analyzed. With a Fourier transform which is generally used as means for analyzing the frequency of a signal, a temporal change in each frequency component cannot be obtained, whereas with a wavelet transform, a temporal change in each frequency component can be obtained. As such, in the first determination process, frequency analysis using a wavelet transform is performed on acceleration data SA.

In general, a wavelet transform W(a, b) is represented by the following equation (1):

W(a,b)=∫_{-∞}^{∞}ψ_{a,b}(t)f(t)dt (1)

Regarding the above equation (1), ψ_{a, b}(t) represents a wavelet function, f(t) represents a signal to be analyzed (in the present embodiment, acceleration data SA), a represents a parameter (scale parameter) proportional to the reciprocal of a frequency, and b represents a parameter (shift parameter) proportional to time. That is, W(a, b) represents output intensity for a combination of time and frequency.

The wavelet function ψ_{a, b}(t) in the above equation (1) is generated by stretching or shrinking and shifting a mother wavelet ψ in the time-axis direction as shown in the following equation (2):

$${ψ}_{a , b} ( t ) = \frac{1}{\sqrt{a}} ψ ( \frac{t - b}{a} ) dt \qquad ( 2 )$$

Note that by substituting the above equation (2) into the above equation (1), the following equation (3) is obtained:

$$W ( a , b ) = \frac{1}{\sqrt{a}} {\int }_{- ∞}^{∞} f ( t ) ψ ( \frac{t - b}{a} ) dt \qquad ( 3 )$$

Meanwhile, in the present embodiment, as the mother wavelet, a “Gabor mother wavelet” which is represented by the following equation (4) is used. The Gabor mother wavelet (Gabor function) is represented as shown in FIG. 15, and is known to be suitable for detection of a local frequency component of a signal.

$$ψ ( t ) = \frac{1}{\sqrt{2 π {σ}^{2}}} exp ( - \frac{{t}^{2}}{2 {σ}^{2}} ) exp ( - i ω t ) \qquad ( 4 )$$

For the above equation (4), σ represents an attenuation coefficient, i represents an imaginary number, and ω represents angular velocity. Note that expZ means Zth power of e (the base of the natural logarithm).

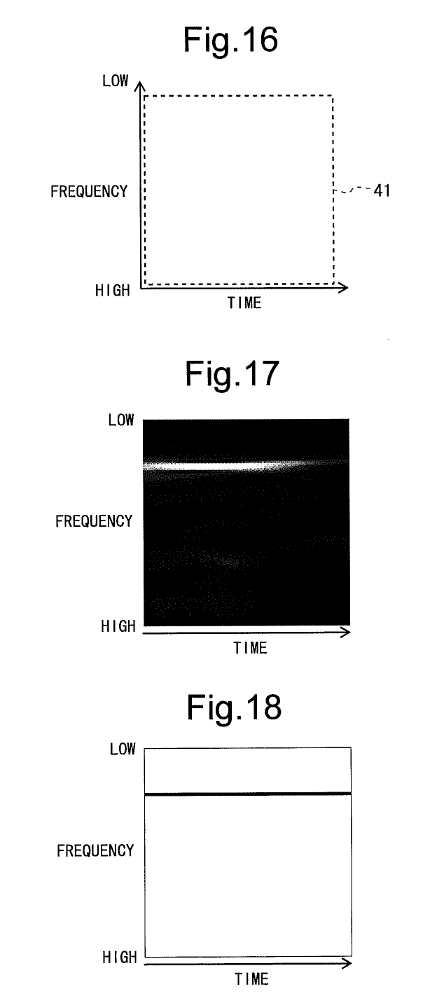

According to such a wavelet transform, a component distribution for combinations of time and frequency is obtained as described above. In general, when this component distribution is depicted, a graph with frequency on the vertical axis and time on the horizontal axis (see FIG. 16) is used, and output intensity (the intensity of a component) is represented by brightness in a region corresponding to combinations of time and frequency (a region indicated by reference character 41 in FIG. 16).

In the present embodiment, a wavelet transform using a Gabor mother wavelet is performed on acceleration data SA which is obtained for a predetermined period of time (e.g., for nine seconds) by the acceleration measuring means 100 (acceleration sensor 18a). Note that a target period for this single process (a period corresponding to the above-described predetermined period of time) is hereinafter referred to as “analysis target period”. In the first determination process, attention is focused on a period (hereinafter, referred to as “presumed walking period”) during which the output intensity is greater than or equal to a predetermined threshold value in a frequency band in which the user is considered to be walking, and it is determined whether the user is walking, taking into account a ratio (hereinafter, referred to as “walking ratio”) of the length of the presumed walking period to the length of the analysis target period. A detailed description is made below.

According to the wavelet transform, a temporal change in output intensity can be obtained for a wide frequency band range. However, it is considered that when the user is walking in a steady state, a strong peak of the output intensity appears in a given limited frequency band range. Hence, in the present embodiment, a frequency band in which it is considered that a strong peak appears when the user is walking in a steady state is set as an analysis target frequency band, and attention is focused only on data on frequencies included in the analysis target frequency band. Specifically, when a wavelet transform is performed on acceleration data SA, the scale parameter a in the above equation (1) is changed such that output intensity (output intensity for combinations of time and frequency) is obtained only for frequencies included in the analysis target frequency band. In addition, the shift parameter b in the above equation (1) is changed such that output intensity for each desired time in the analysis target period is obtained. By thus changing the scale parameter a and the shift parameter b as appropriate when performing a wavelet transform on acceleration data SA, data that is required to determine whether the user is walking is effectively extracted. Note that depending on the purpose, it is also possible to set an analysis target frequency band such that data on the user who are running are extracted in addition to data on the user who are walking, or set an analysis target frequency band such that only data on the user who are running are extracted.

In addition, even when a peak of the output intensity is continuously observed throughout the analysis target period, if the output intensity of the peak is low, then the peak is not necessarily caused by walking action. Hence, in the present embodiment, attention is focused on data in which the output intensity is greater than or equal to a certain threshold value in the analysis target frequency band. Specifically, a threshold value (hereinafter, referred to as “intensity threshold value” for convenience sake) for comparing with the output intensity is set in advance, and a period during which the output intensity is greater than or equal to the intensity threshold value in the analysis target frequency band is set as the above-described presumed walking period. Note that a first threshold value is implemented by the intensity threshold value.

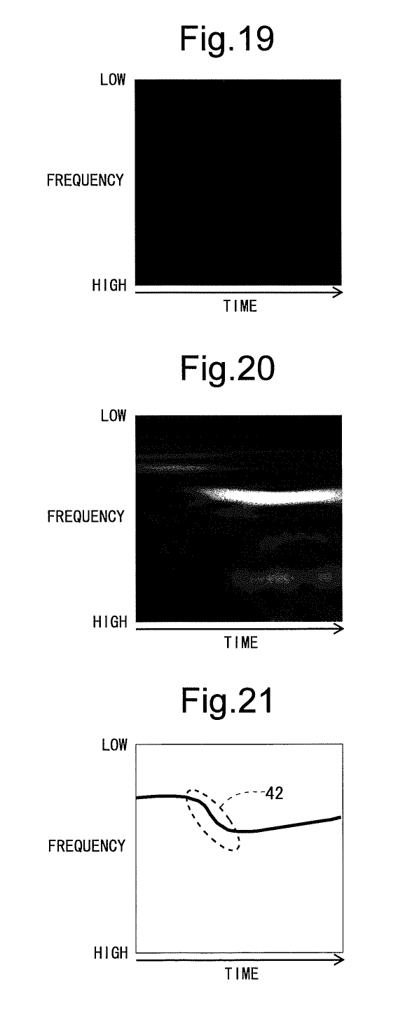

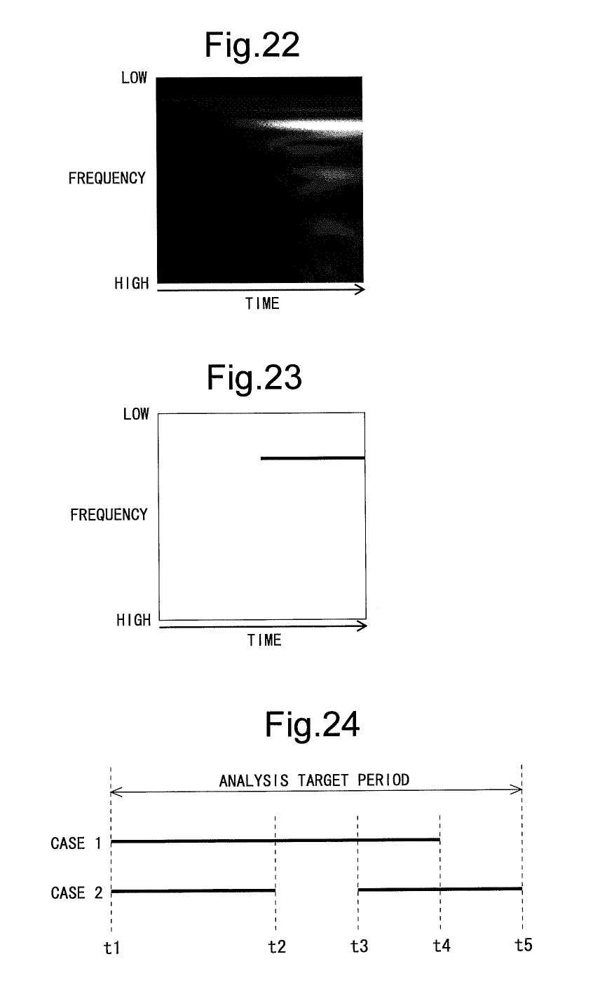

Here, examples of component distributions which are obtained by performing a wavelet transform on acceleration data SA are shown. FIG. 17 is a diagram showing a first example of a component distribution. FIG. 18 is a diagram schematically showing, by a thick line, a portion in which output intensity greater than or equal to the intensity threshold value appears in the first example. The first example is an example for when the user is walking in a steady state throughout the analysis target period. In the first example, the walking ratio is 100%. FIG. 19 is a diagram showing a second example of a component distribution. In the second example, there is no portion in which output intensity greater than or equal to the intensity threshold value appears. That is, the walking ratio is 0%. FIG. 20 is a diagram showing a third example of a component distribution. FIG. 21 is a diagram schematically showing, by a thick line, a portion in which output intensity greater than or equal to the intensity threshold value appears in the third example. The third example is an example for when a temporary change has occurred in walking speed for some reason during walking in a steady state. In the third example, the walking ratio is 100%. FIG. 22 is a diagram showing a fourth example of a component distribution. FIG. 23 is a diagram schematically showing, by a thick line, a portion in which output intensity greater than or equal to the intensity threshold value appears in the fourth example. The fourth example is an example for when the user has started walking action in the middle of the analysis target period. In the fourth example, the walking ratio is about 50%.

Meanwhile, a period (presumed walking period) during which the output intensity is greater than or equal to the above-described intensity threshold value in the analysis target period is not always one uninterrupted period, which will be described with reference to FIG. 24. In FIG. 24, a presumed walking period is represented by a thick line. In case 1, a presumed walking period is one uninterrupted period (continuous period). In this case 1, the ratio of the “length of a period from time point t1 to time point t4” to the “length of a period from time point t1 to time point t5” is a walking ratio. In case 2, a part of the first half period of the analysis target period and a part of the second half period of the analysis target period are presumed walking periods. In this case 2, the ratio of the “sum of the length of a period from time point t1 to time point t2 and the length of a period from time point t3 to time point t5” to the “length of a period from time point t1 to time point t5” is a walking ratio.

In the present embodiment, a threshold value (hereinafter, referred to as “ratio threshold value” for convenience sake) for comparing with a walking ratio such as that described above is determined in advance. Then, in the first determination process, the walking ratio is compared with the ratio threshold value. If the walking ratio is greater than or equal to the ratio threshold value, it is determined that the “user is walking”. If the walking ratio is less than the ratio threshold value, it is determined that the “user is not walking”. Note that a second threshold value is implemented by the ratio threshold value.

Meanwhile, for example, immediately after starting walking, the walking state is not a steady state, and thus, even if the congestion degree is estimated based on acceleration data SA obtained in such a case, it is highly likely that a correct estimation result cannot be obtained. On the other hand, even if walking in a steady state is performed, the output intensity for frequencies included in the analysis target frequency band may temporarily become less than the intensity threshold value due to congestion. Data for such cases is data useful for estimating the congestion degree. Hence, it is preferable to set the ratio threshold value to a suitable value, taking into account the above-described points.

Note that the ratio threshold value may be set to an appropriate value, according to the purpose of a use of the result of a walking determination process. For example, when a high possibility of inclusion of noise data is allowed, the ratio threshold value is set to a small value, by which more users can be determined to be walking.

### <5.3 Second Determination Process (Determination Based on Azimuth Data)>

As described above, the second determination process is a process of making a determination based on azimuth data Hda. In general, it is considered that when a person is walking toward a given destination, the movement of the body is small and the orientation of the body is substantially constant. On the other hand, it is considered that when a person is doing a tourist activity, etc., there is a large change in the orientation of the body. Hence, in the second determination process, the change amount in azimuth angle per unit of time is obtained based on azimuth data Hda which is obtained by the azimuth detecting means 110 (geomagnetic sensor 18b). When the change amount is less than or equal to a predetermined threshold value, it is determined that the “user is walking”. When the change amount is greater than the predetermined threshold value, it is determined that the “user is not walking”. Note, however, that even when the user is performing normal walking toward a destination, the value of azimuth data Hda greatly changes at a corner point, and thus, it is preferred to determine whether the user's current location is at a corner point, using location data Pda and route information (information on a route search result Re obtained by the route searching means 180), so that the second determination process is not performed at the corner point. Note that a third threshold value is implemented by the predetermined threshold value for comparing with the change amount per unit of time.

Meanwhile, it is considered that when ideal walking is performed, the body moves left and right in certain cycles. Therefore, as with performing frequency analysis on acceleration data SA, for a determination based on azimuth data Hda, too, it is also possible to perform frequency analysis on azimuth data Hda and make a determination based on the results of the frequency analysis.

### <5.4 Third Determination Process (Determination Based on Location Data)>

As described above, the third determination process is a process of making a determination based on location data Pda. It is considered that when a person is walking toward a given destination, even if the walking speed is low, he/she moves forward a certain amount of distance per unit of time. On the other hand, it is considered that when a person is doing a tourist activity, etc., he/she stays in a certain range in many cases. Hence, in the third determination process, a travel distance per unit of time is obtained based on location data Pda which is obtained by the location data obtaining means 120 (GPS sensor 18c). When the travel distance is greater than or equal to a predetermined threshold value, it is determined that the “user is walking”. When the travel distance is less than the predetermined threshold value, it is determined that the “user is not walking”. Note that a fourth threshold value is implemented by the predetermined threshold value for comparing with the travel distance per unit of time.

Meanwhile, when the user is present at a location with a low intensity of GPS radio waves (an area with many buildings, a basement, an indoor place, etc.), the accuracy of a location which is obtained by the GPS sensor 18c is low, and thus, it is preferable not to perform the third determination process. Note, however, that even when the user is present at such a location, if a device that emits radio waves to provide location information (e.g., a device called a “beacon”) is installed, then the third determination process may be performed.

### <5.5 Procedure of a Walking Determination Process>

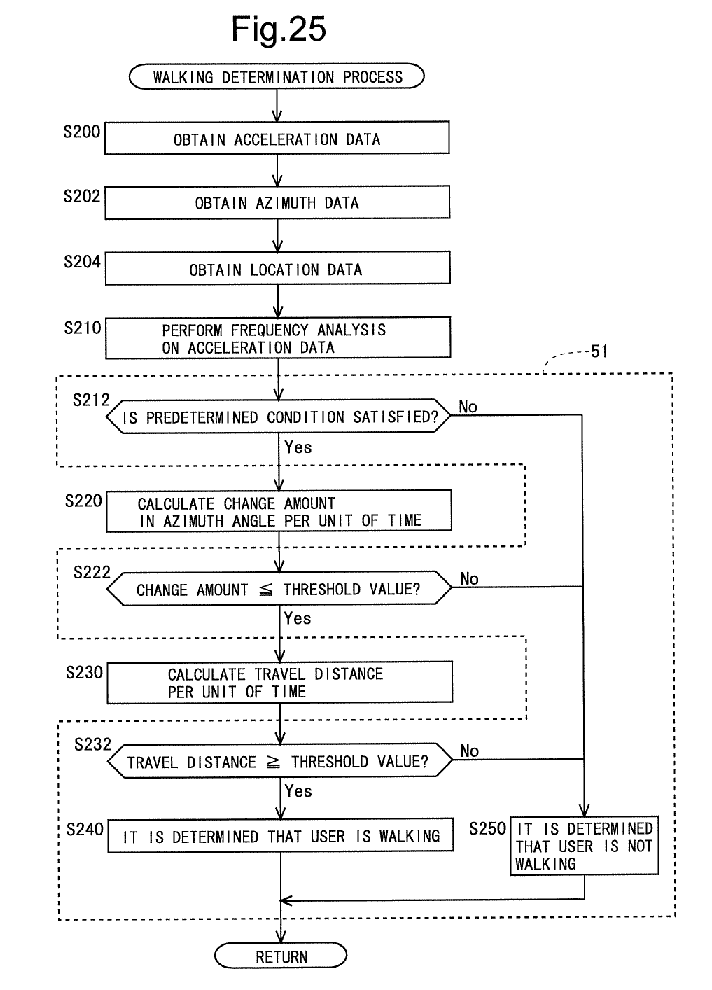

Next, with reference to FIG. 25, a procedure of a walking determination process in the present embodiment will be described. After starting a walking determination process, first, the acceleration measuring means 100 (acceleration sensor 18a) obtains acceleration data SA (step S200). Then, the azimuth detecting means 110 (geomagnetic sensor 18b) obtains azimuth data Hda (step S202). Furthermore, the location data obtaining means 120 (GPS sensor 18c) obtains location data Pda (step S204). Note that although here it is shown that the processes at step S200 to S204 are performed sequentially, in practice, the processes at step S200 to S204 are performed simultaneously and parallelly.

Thereafter, frequency analysis using a wavelet transform is performed on the acceleration data SA obtained at step S200 (step S210). Then, it is determined whether the results of the frequency analysis satisfy a predetermined condition (the above-described condition that “the walking ratio is greater than or equal to the ratio threshold value”) (step S212). As a result of the determination, if the predetermined condition is satisfied, processing proceeds to step S220, and if the predetermined condition is not satisfied, processing proceeds to step S250. Note that the processes at step S210 and step S212 correspond to the above-described first determination process.

Then, a change amount in azimuth angle per unit of time is calculated based on the azimuth data Hda obtained at step S202 (step S220). Then, it is determined whether the change amount is less than or equal to a predetermined threshold value (step S222). As a result of the determination, if the change amount is less than or equal to the threshold value, processing proceeds to step S230, and if the change amount is greater than the threshold value, processing proceeds to step S250. Note that the processes at step S220 and step S222 correspond to the above-described second determination process.

Then, a travel distance per unit of time is calculated based on the location data Pda obtained at step S204 (step S230). Then, it is determined whether the travel distance is greater than or equal to a predetermined threshold value (step S232). As a result of the determination, if the travel distance is greater than or equal to the threshold value, processing proceeds to step S240, and if the travel distance is less than the threshold value, processing proceeds to step S250. Note that the processes at step S230 and step S232 correspond to the above-described third determination process.

At step S240, it is determined that the relevant user is walking. At step S250, it is determined that the relevant user is not walking. In the above-described manner, the walking determination process ends.

Note that, in the present embodiment, a determining step is implemented by step S212, S222, S232, S240, and S250 (a portion indicated by a dotted line denoted by reference character 51 in FIG. 25).

### <6. Effects>

According to the present embodiment, the portable terminal device 10 performs frequency analysis on acceleration data SA, and obtains output intensity corresponding to each combination of time and frequency, as the results of the analysis. That is, regarding acceleration data SA, a temporal change in each frequency component can be grasped. Since a change in human movement is reflected in acceleration data SA, it becomes possible to determine whether a user of the portable terminal device is walking by grasping a temporal change in each frequency component regarding the acceleration data SA. In addition, upon frequency analysis, a frequency band in which it is considered that a strong peak appears when walking in a steady state is performed is set as an analysis target frequency band. Then, a period during which the output intensity is greater than or equal to a certain threshold value (intensity threshold value) in the analysis target frequency band is set as a presumed walking period. Taking into account the ratio of the length of the presumed walking period to the length of the analysis target period, it is determined whether the user is walking. Hence, even if there is a change in the walking speed of the user during the analysis target period such as a portion indicated by a dotted line denoted by reference character 42 in FIG. 21, a determination can be made properly. As described above, according to the present embodiment, a determination as to whether the user of the portable terminal device is walking can be made accurately.

In addition, according to the present embodiment, regarding the determination as to whether the user of the portable terminal device 10 is walking, a determination based on azimuth data Hda (a determination based on the change amount in azimuth angle per unit of time) and a determination based on location data Pda (a determination based on the travel distance per unit of time) are performed in addition to a determination based on acceleration data SA. Hence, a determination as to whether the user of the portable terminal device 10 is walking is made more accurately.

Furthermore, according to the present embodiment, only data on the users (the users of the portable terminal devices 10) who are walking serves as data that is the source of estimation, on the server 20 side, of the congestion degree (the average congestion degree CAV for each mesh). That is, noise data (data on users who are doing a tourist activity, etc.) that inhibits the accurate estimation of the congestion degree is excluded from data that is the source of estimation of the congestion degree. By this, the accuracy of estimation of the congestion degree on the server 20 side improves.

### <7. Variants>

Variants of the above-described embodiment will be described below.

### <7.1 Variant Regarding Frequency Analysis>

In the above-described embodiment, frequency analysis using a wavelet transform is performed on acceleration data SA. However, the present invention is not limited thereto, and frequency analysis using a short-time Fourier transform may be performed on acceleration data SA, which will be described below.

In general, a Fourier transform F(ω) is represented by the following equation (5):

F(ω)=∫_{-∞}^{∞}f(t)exp(−iωt)dt (5)

Regarding the above equation (5), f(t) represents a signal to be analyzed, i represents an imaginary number, and ω represents angular velocity.

As can be grasped from the above equation (5), what is obtained from the Fourier transform is component information for each frequency. That is, with the Fourier transform, a temporal change in each frequency component cannot be obtained. Hence, as frequency analysis means to which the Fourier transform is applied, there is known a short-time Fourier transform F (ω, τ) represented by the following equation (6):

F(ω,τ)=∫_{-∞}^{∞}w(t−τ)f(t)exp(−iωt)dt (6)

Regarding the above equation (6), w (t−τ) represents a window function, τ represents the time taken to shift the window function, f(t) represents a target signal, i represents an imaginary number, and ω represents angular velocity.

As can be grasped from the above equation (6), in the short-time Fourier transform, a Fourier transform is performed on a signal represented by the product of a function called a window function for locally cutting out a signal and a signal to be analyzed. At that time, the product of the window function and the signal to be analyzed is obtained while the window function is shifted on the time axis. Therefore, a frequency component distribution for each short period of time can be obtained for the signal to be analyzed. That is, according to the short-time Fourier transform, a temporal change in each frequency component can be obtained.

As described above, by the short-time Fourier transform, too, a temporal change in each frequency component can be obtained. Therefore, even if the short-time Fourier transform is adopted as specific means for performing frequency analysis on acceleration data SA, as in the above-described embodiment, output intensity corresponding to each combination of time and frequency can be obtained for acceleration data SA. That is, regarding the above-described first determination process, it is also possible to perform a short-time Fourier transform on acceleration data SA, and determine whether a user is walking, based on the results of the short-time Fourier transform.

### <7.2 Variant Regarding Determination Source Data Used Upon a Walking Determination Process>

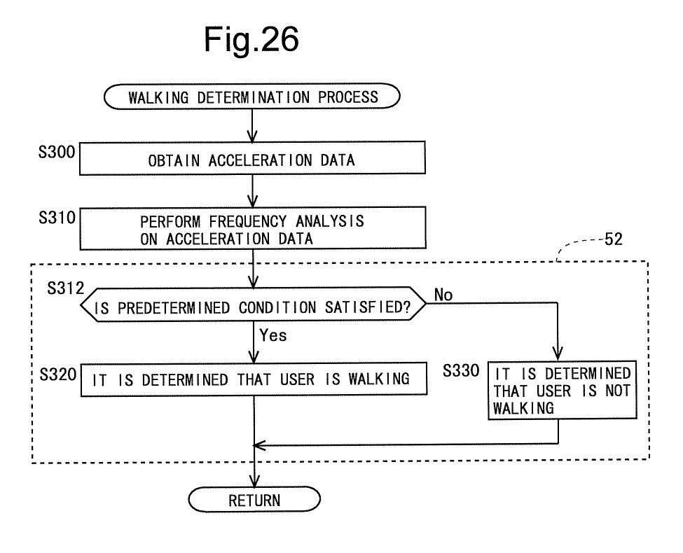

In the above-described embodiment, upon a walking determination process, three types of determination processes (the first to third determination processes) are performed. However, the present invention is not limited thereto, and the configuration may be such that only the first determination process (a determination based on acceleration data SA) is performed. FIG. 26 is a flowchart showing a procedure of a walking determination process for the case of performing only the first determination process. In this case, first, as with step S200 in the above-described embodiment (see FIG. 25), the acceleration measuring means 100 (acceleration sensor 18a) obtains acceleration data SA (step S300). Then, as with step S210 in the embodiment, frequency analysis is performed on the acceleration data SA (step S310). Thereafter, as with step S212 in the embodiment, it is determined whether the results of the frequency analysis satisfy a predetermined condition (step S312). Then, if the predetermined condition is satisfied, it is determined that the relevant user is walking (step S320), and if the predetermined condition is not satisfied, it is determined that the relevant user is not walking (step S330). In this example, a determining step is implemented by step S312, S320, and S330 (a portion indicated by a dotted line denoted by reference character 52 in FIG. 26). Note that the configuration may be such that the first determination process and “one of the second determination process and the third determination process” are performed upon a walking determination process.

Further, a determination process based on data that is obtained by a sensor other than the sensors described in the embodiment may be added. For example, a determination process based on data that is obtained by a magneto sensor (magnetic sensor) or a determination process based on data that is obtained by a gyro sensor may be added. Note that the magneto sensor is a sensor that detects the magnitude and direction of a magnetic field, and the gyro sensor is a sensor that detects angular velocity (rotation angle per unit of time). For the data obtained by the magneto sensor and gyro sensor, too, the value periodically changes by walking. Therefore, it is possible to perform frequency analysis on those pieces of data and to make a determination as to whether a user is walking based on the results of the frequency analysis. Regarding this, the configuration may be such that, after a determination as to whether there is periodicity is made according to a predetermined determination condition, if there is periodicity, it is determined (tentatively determined) that the “user is walking”, and if there is no periodicity, it is determined (tentatively determined) that the “user is not walking”.

Although the present invention has been described in detail above, the above description is to be considered in all respects as illustrative and not restrictive. It will be understood that many other changes and modifications may be made without departing from the spirit and scope of the present invention.

Note that this application claims priority based on Japanese Patent Application No. 2016-235587 titled “Walking Determination Method and Walking Determination Program” filed on Dec. 5, 2016, the content of which is incorporated herein by reference.

What is claimed is:

1. A walking determination method for determining whether a user of a portable terminal device is walking, the walking determination method comprising:
an acceleration data obtaining step of obtaining acceleration data representing acceleration of the portable terminal device for a predetermined period of time;
an analyzing step of obtaining, as an analysis result, output intensity corresponding to each combination of time and frequency by performing frequency analysis on the acceleration data; and
a determining step of determining whether the user is walking, taking into account the analysis result obtained in the analyzing step.

2. The walking determination method according to claim 1, wherein in the determining step, the determination as to whether the user is walking is made taking into account a ratio of a period during which the output intensity is greater than or equal to a predetermined first threshold value in a predetermined frequency band range, to the predetermined period of time.

3. The walking determination method according to claim 2, wherein in the determining step, it is determined that the user is not walking, when the ratio of the period during which the output intensity is greater than or equal to the first threshold value in the predetermined frequency band range, to the predetermined period of time, is less than a predetermined second threshold value.

4. The walking determination method according to claim 2, wherein in the analyzing step, output intensity corresponding to the combination of time and frequency is obtained only for frequencies included in the predetermined frequency band range.

5. The walking determination method according to claim 1, further comprising:
an azimuth data obtaining step of obtaining azimuth data representing an azimuth angle depending on orientation of the portable terminal device; and
a change amount calculating step of calculating a change amount in azimuth angle per unit of time, based on the azimuth data, wherein
in the determining step, the determination as to whether the user is walking is made further taking into account the change amount.

6. The walking determination method according to claim 5, wherein in the determining step, it is determined that the user is not walking, when the change amount is greater than a predetermined third threshold value.

7. The walking determination method according to claim 1, further comprising:
a location data obtaining step of obtaining location data representing a location of the portable terminal device; and
a travel distance calculating step of calculating a travel distance based on the location data, the travel distance being a difference between locations per unit of time, wherein
in the determining step, the determination as to whether the user is walking is made further taking into account the travel distance.

8. The walking determination method according to claim 7, wherein in the determining step, it is determined that the user is not walking, when the travel distance is less than a predetermined fourth threshold value.

9. The walking determination method according to claim 1, wherein in the analyzing step, frequency analysis using a wavelet transform is performed on the acceleration data.

10. The walking determination method according to claim 1, wherein in the analyzing step, frequency analysis using a short-time Fourier transform is performed on the acceleration data.

11. A computer-readable recording medium having recorded therein a walking determination program for determining whether a user of a portable terminal device is walking, the walking determination program causing a computer to perform:
an acceleration data obtaining step of obtaining acceleration data representing acceleration of the portable terminal device for a predetermined period of time;
an analyzing step of obtaining, as an analysis result, output intensity corresponding to each combination of time and frequency by performing frequency analysis on the acceleration data; and
a determining step of determining whether the user is walking, taking into account the analysis result obtained in the analyzing step.

12. The computer-readable recording medium according to claim 11, wherein in the determining step, the determination as to whether the user is walking is made taking into account a ratio of a period during which the output intensity is greater than or equal to a predetermined first threshold value in a predetermined frequency band range, to the predetermined period of time.

13. The computer-readable recording medium according to claim 12, wherein in the determining step, it is determined that the user is not walking, when the ratio of the period during which the output intensity is greater than or equal to the first threshold value in the predetermined frequency band range, to the predetermined period of time, is less than a predetermined second threshold value.

14. The computer-readable recording medium according to claim 12, wherein in the analyzing step, output intensity corresponding to the combination of time and frequency is obtained only for frequencies included in the predetermined frequency band range.

15. The computer-readable recording medium according to claim 11, wherein the walking determination program causes the computer to further perform:
an azimuth data obtaining step of obtaining azimuth data representing an azimuth angle depending on orientation of the portable terminal device; and
a change amount calculating step of calculating a change amount in azimuth angle per unit of time, based on the azimuth data, wherein
in the determining step, the determination as to whether the user is walking is made further taking into account the change amount.

16. The computer-readable recording medium according to claim 15, wherein in the determining step, it is determined that the user is not walking, when the change amount is greater than a predetermined third threshold value.

17. The computer-readable recording medium according to claim 11, wherein the walking determination program causes the computer to further perform:
a location data obtaining step of obtaining location data representing a location of the portable terminal device; and
a travel distance calculating step of calculating a travel distance based on the location data, the travel distance being a difference between locations per unit of time, wherein
in the determining step, the determination as to whether the user is walking is made further taking into account the travel distance.

18. The computer-readable recording medium according to claim 17, wherein in the determining step, it is determined that the user is not walking, when the travel distance is less than a predetermined fourth threshold value.

19. The computer-readable recording medium according to claim 11, wherein in the analyzing step, frequency analysis using a wavelet transform is performed on the acceleration data.

20. The computer-readable recording medium according to claim 11, wherein in the analyzing step, frequency analysis using a short-time Fourier transform is performed on the acceleration data.
